(19) United States
(12) Patent Application Publication
(10) Pub. No.: US 2025/0054029 A1
(43) Pub. Date: Feb. 13, 2025

(54) Gemstone Grading Report Including Weblink to Current Pricing and/or Value Information and Methods

(71) Applicant: Digital Mining, LLC, Asheville, NC (US)

(72) Inventor: Elliott Spicer, Asheville, NC (US)

(73) Assignee: Digital Mining, LLC, Asheville, NC (US)

(21) Appl. No.: 18/918,390

(22) Filed: Oct. 17, 2024

Related U.S. Application Data
(63) Continuation-in-part of application No. 18/781,339, filed on Jul. 23, 2024.
Application No. 18/781,339 is a continuation-in-part of application No. 18/070,632, filed on Nov. 29, 2022.
(60) Provisional application No. 63/545,975, filed on Oct. 27, 2023.
(60) Provisional application No. 63/286,141, filed on Dec. 6, 2021.

(51) Int. Cl. G06Q 30/02; G06K 19/06

(52) U.S. Cl. CPC G06Q 30/0278; G06K 19/06037

(57) ABSTRACT

A gemstone grading report system. The gemstone grading report system may include a gemstone grading report associated with a gemstone; gemstone data of the gemstone displayed or printed on the gemstone grading report; and one or more weblinks including machine readable media displayed or printed on the gemstone grading report, wherein at least one of the one or more weblinks is configured to, upon reading the machine readable media by a computing device, link the computing device to real-time pricing information of the gemstone.

### CROSS-REFERENCE TO RELATED APPLICATIONS

This application is a continuation-in-part of U.S. patent application Ser. No. 18/781,339, filed Jul. 23, 2024, the application of which is a continuation-in-part of U.S. patent application Ser. No. 18/070,632, filed Nov. 29, 2022, the application of which claims priority to U.S. Provisional Application No. 63/286,141, filed Dec. 6, 2021, the entire disclosures of which are incorporated herein by reference.

This application is related and claims priority to U.S. Provisional Patent Application No. 63/545,975, filed on Oct. 27, 2023 the application of which is incorporate herein by reference in its entirety.

### TECHNICAL FIELD

The subject matter relates generally to a gemstone grading report and more particularly to a gemstone grading report including a weblink (such as a bar code) enabled to link to real-time pricing and/or value information.

### SUMMARY

In one embodiment, a gemstone grading report system is provided. The gemstone grading report system may include a gemstone grading report associated with a gemstone; gemstone data of the gemstone displayed or printed on the gemstone grading report; and one or more weblinks including machine readable media displayed or printed on the gemstone grading report, wherein at least one of the one or more weblinks is configured to, upon reading the machine readable media by a computing device, link the computing device to real-time pricing information of the gemstone. The gemstone data may include characteristics of the gemstone, the characteristics may include one or more of gemstone type, cut, color, clarity, carat, size, fluorescence, lab grade, dimensions, diagrams, certificate number, images, grading lab, source, and/or source history of gemstone. The one or more weblinks comprises at least two weblinks, and wherein one of the at least two weblinks is configured to link the computing device to certificate information of the gemstone. The gemstone grading report may include one of a digital/electronic format and/or a physical format. The machine readable media of the one or more weblinks may include any of a QR code or a bar code. The pricing information of the gemstone may include current pricing and/or value information that is assessable in real time. The system may further include a live pricing application, wherein the computing device automatically accesses the live pricing application upon reading the machine readable media, and wherein the live pricing application may include a live pricing algorithm and a live pricing tool graphical user interface. The live pricing application may be further configured to automatically query one or more online gemstone trading platforms for pricing information of gemstones comparable to the gemstone of the gemstone grading report. The live pricing application may be further configured to automatically analyze the queried pricing information, and using the live pricing algorithm calculate in real-time the real-time pricing information for the gemstone of the gemstone grading report. The real-time pricing information may include an average dealer price for the gemstone of the gemstone grading report. The real-time pricing information further may include either or both of a calculated retail price and/or a calculated buy price for the gemstone of the gemstone grading report. Calculating the average dealer price may include averaging the real-time pricing information for all gemstones retrieved from the query of the one or more online gemstone trading platforms. Calculating the average dealer price further may include averaging the real-time pricing information for all gemstones retrieved from the query of the one or more online gemstone trading platforms going back a defined period of time and generating historical average dealer prices spanning over the defined period of time. The calculated real-time pricing information may be viewable via the live pricing tool graphical user interface.

In another embodiment, a method of using a gemstone grading report system is provided. The method may include providing a gemstone grading report of a gemstone. The gemstone grading report may include gemstone data of the gemstone displayed or printed on the gemstone grading report; and one or more weblinks that may include machine readable media displayed or printed on the gemstone grading report, wherein at least one of the one or more weblinks is configured to, upon reading the machine readable media by a computing device, link the computing device to real-time pricing information of the gemstone. The method may further include activating the at least one of the one or more weblinks, wherein activating the at least one of the one or more weblinks may include reading the machine readable media by the computing device; accessing a live pricing application of a gemstone pricing tool via the activated one of the one or more weblinks; and viewing the real-time pricing information of the gemstone. The method may further include after accessing the live pricing application, entering any additional required information of the gemstone into the live pricing application not automatically entered therein. The gemstone data may include characteristics of the gemstone, the characteristics comprising one or more of gemstone type, cut, color, clarity, carat, size, fluorescence, lab grade, dimensions, diagrams, certificate number, images, grading lab, source, and/or source history of gemstone. The one or more weblinks may include at least two weblinks, and wherein one of the at least two weblinks is configured to link the computing device to certificate information of the gemstone. The gemstone grading report may include one of a digital/electronic format and/or a physical format. The machine readable media of the one or more weblinks may include any of a QR code or a bar code. The pricing information of the gemstone may include current pricing and/or value information that is assessable in real time. The method may further include a live pricing application, wherein the computing device accesses the live pricing application upon reading the machine readable media, and wherein the live pricing application may include a live pricing algorithm and a live pricing tool graphical user interface. The live pricing application may be further configured to query one or more gemstone trading platforms for pricing information of gemstones having substantially similar characteristics as that of the gemstone of the gemstone grading report. The live pricing application may be further configured to analyze the queried pricing information and using the live pricing algorithm calculate the real-time pricing information for the gemstone of the gemstone grading report.

### BACKGROUND

Traditionally, the gemstone industry, and in particular the diamond industry, has always been a very secretive industry with little transparency for the end consumers. When buying a gemstone, e.g., a diamond, end consumers are forced to “trust” the retailer they are buying from, that they are getting a fair deal. In the retail landscape for diamonds, for example, the markup can be as much as 400% to as little as 15% for the exact same diamond, and the end consumer has no way of knowing the percent markup being applied. That is, in the gemstone (or diamond) industry the customer typically has no idea about the percent markup when buying or the percent markdown when selling their gemstone. Accordingly, the customer typically has no idea what kind of deal they are getting.

Therefore, there is a need for improved transparency in the buying and selling of gemstones. Further, new approaches are needed wherein the customer may know exactly what the pricing data is and can see whether they are getting a fair deal, which builds trust and possibly repeat business for the dealer.

### BRIEF DESCRIPTION OF THE DRAWINGS

Having thus described the subject matter in general terms, reference will now be made to the accompanying drawings, which are not necessarily drawn to scale, and wherein:

FIG. 1 illustrates a block diagram of an example of a gemstone management system, in accordance with an embodiment of the invention;

FIG. 2 illustrates an example screenshot of the gemstone management system, in accordance with an example embodiment of the invention;

FIG. 3 illustrates a screenshot of an example of a diamond grading report including a weblink enabled to link to real-time diamond and gemstone pricing and/or value information, in accordance with an example embodiment of the invention;

FIG. 4A through FIG. 4G illustrate screenshots of an example of an online diamond pricing tool that may be accessed using the weblink on the diamond grading report, in accordance with an example embodiment of the invention;

FIG. 5 illustrates a flow diagram of an example of a method of using the gemstone management system with the diamond grading report including a weblink, in accordance with an embodiment of the invention; and

FIGS. 6A-6C illustrate screenshots of an example of an online diamond pricing tool that includes a gemstone guaranteed buy price application.

### DETAILED DESCRIPTION

The subject matter now will be described more fully hereinafter with reference to the accompanying drawings, in which some, but not all embodiments of the subject matter are shown. Like numbers refer to like elements throughout. The subject matter may be embodied in many different forms and should not be construed as limited to the embodiments set forth herein; rather, these embodiments are provided so that this disclosure will satisfy applicable legal requirements. Indeed, many modifications and other embodiments of the subject matter set forth herein will come to mind to one skilled in the art to which the subject matter pertains having the benefit of the teachings presented in the foregoing descriptions and the associated drawings. Therefore, it is to be understood that the subject matter is not to be limited to the specific embodiments disclosed and that modifications and other embodiments are intended to be included within the scope of the appended claims.

In some embodiments, the subject matter provides a gemstone grading report including weblink (such as a bar code) to current real-time pricing and/or value information and methods.

In some embodiments, the gemstone management system and methods provide a diamond or gemstone grading report that may further include one or more weblinks to other information about the diamond or gemstone.

In some embodiments, the gemstone management system and methods provide a diamond or gemstone grading report that may further include a pricing weblink, such as a pricing QR code, bar code, or any other type of readable media that may be used to access online pricing data along with other related information via a linked webpage or online diamond pricing tool.

Throughout the description the term “gemstone” shall also be interpreted to include not only gemstones, but may also include articles of jewelry, which would also include watches.

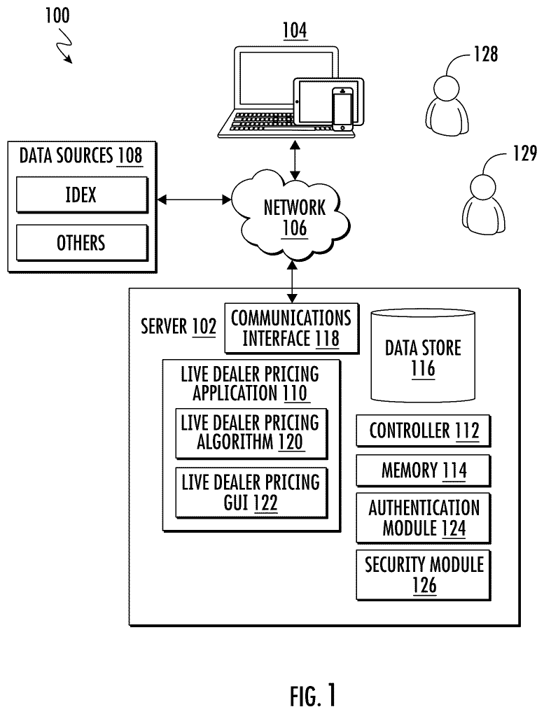

Referring now to FIG. 1 is a block diagram of an example of a gemstone management system 100, in accordance with an embodiment of the invention. Gemstone management system 100 may include, for example, a server 102, connected to one or more user computers 104 via a network 106, and one or more data sources 108.

Server 102 may further include a live dealer pricing application 110, a controller 112 that may include a certain amount of operating memory 114, a data store 116, and a communications interface 118. Controller 112 may be any standard controller or microprocessor device that is capable of executing program instructions. Controller 112 may be used to manage the overall operations of gemstone management system 100. Memory 114 may be any volatile or non-volatile memory device. Memory 114 may be built into or separate from controller 112. Data store 108 may be, for example, data repositories (like databases) and/or flat files that can store data. In one example, data store 116 may be a Structured Query Language (SQL) database. Further, gemstone management system 100 is not limited to one data store 108 only. Gemstone management system 100 may include multiple data stores 108.

Server 102 may be, for example, an application server. Server 102 can be any networked computing configuration as long as it is accessible by user computers 104, and any of the data sources 108. Each of the user computers 104 may be operated by one or more users 128. Users 128 may be, for example, gemstone retailers and/or dealers. Additionally, customers 129 may be associated with gemstone management system 100. That is, customers 129 may be customers of users 128, who may be the gemstone retailers and/or dealers.

Gemstone management system 100, and more particularly live dealer pricing application 110, may support a cloud computing environment. In a cloud computing environment, server 102 may be the cloud server. Further, live dealer pricing application 110 is not limited to running on one server 102 only. Gemstone management system 100 may include multiple servers 102 (or cloud servers) in order to ensure high-availability of computing resources.

At server 102, live dealer pricing application 110 may further include one or more of a live dealer pricing algorithm 120 and a live dealer pricing tool graphical user interface (GUI) 122. Server 102 may further include an authentication module 124 and a security module 126. Generally, live dealer pricing application 110 at server 102 may be a software and/or hardware application. Additionally, server 102 may be accessible via network 106. Network 106 may be, for example, a local area network (LAN), a wide area network (WAN), and/or a cellular network for connecting to the Internet or to an Intranet. Server 102 may connect to network 106 by any wired and/or wireless means.

Each of the user computers 104 may be any computing device, such as, but not limited to, a desktop computer, a laptop computer, a handheld computing device, a mobile phone (or smart phone), a tablet device, a smartwatch, and/or the like. Users 128 may access live dealer pricing application 110 at server 102 via their respective user computers 104 and network 106. Network 106 may be, for example, a local area network (LAN) and/or a wide area network (WAN) for connecting to the Internet or to an Intranet. Server 102 and user computer 104 may connect to network 106 by any wired and/or wireless means. For example, server 102 may connect to network 106 via communications interface 118.

Communications interface 118 may be any wired and/or wireless communication interface for connecting to a network (e.g., network 106) and by which information may be exchanged with other devices connected to the network. Examples of wired communication interfaces may include, but are not limited to, USB ports, RS232 connectors, RJ45 connectors, Ethernet, and any combinations thereof. Examples of wireless communication interfaces may include, but are not limited to, an Intranet connection, Internet, ISM, Bluetooth® technology, Bluetooth® Low Energy (BLE) technology, Wi-Fi, Wi-Max, IEEE 402.11 technology, ZigBee technology, Z-Wave technology, 6LoWPAN technology (i.e., IPv6 over Low Power Wireless Area Network (6LoWPAN)), ANT or ANT+ (Advanced Network Tools) technology, radio frequency (RF), Infrared Data Association (IrDA) compatible protocols, Local Area Networks (LAN), Wide Area Networks (WAN), Shared Wireless Access Protocol (SWAP), cellular networks, any combinations thereof, and other types of wireless networking protocols.

Data sources 108 may include any sources of information that may be useful to live dealer pricing application 110, such as real-time dealer/wholesale trade values of gemstones, such as diamonds. Data sources 108 may include, for example, one or more online gemstone trading platforms, such as, but not limited to, the International Diamond Exchange (IDEX), Rapnet, Polygon, Virtual diamond Boutique, and/or the like.

In one example, users 128 may interact with the live dealer pricing application 110 using live dealer pricing tool GUI 122 at server 102. In this example, live dealer pricing tool GUI 122 may be a web-based GUI that is accessible via network 106. For example, live dealer pricing application 110 at server 102 may be a software application that may be implemented as a web application and run in a web browser, such as Google Chrome or Microsoft Edge.

A desktop application or mobile app may be installed and running on each of the user computers 104. Such a desktop application or mobile app may be implemented, for example, as a .NET application, a desktop application, a mobile app, an application program interface (API), and the like, and may be designed to operate on any device platform, including for example, Windows, Android, Apple, and the like. Accordingly, users 128 may interact with the live dealer pricing application 110 using a desktop or mobile app of their user computer 104 (e.g., smart phone or tablet device).

In one example, authentication module 124 may be used to manage the authentication process of any entities of gemstone management system 100, such as users 128 (retailer/dealer). For example, when the user 128 access gemstone management system 100, a standard authentication process may be performed that allows the user 128 to access one of the applications running on the server 102, such as, live dealer pricing application 110. Users 128 may sign in using one of any number of ways. In one example, the user 128 may use a web browser to access live dealer pricing tool GUI 122 of live dealer pricing application 110 and enter credentials (e.g., username and password).

In one example, security module 126 of gemstone management system 100 may be used to perform any system security functions with respect to keeping secure the contents of data store 116 and/or any other information with respect to gemstone management system 100. Security module 126 may use standard security techniques, such as encryption, secure hashtags (or hash tags), and the like.

In one example, live dealer pricing algorithm 120 may be used to process information generated and/or received by live dealer pricing application 110 and thereby manage operations of gemstone management system 100. In one example, live dealer pricing algorithm 120 may be used to process a gemstone's, e.g., diamond's, dealer pricing information retrieved from one or more online gemstone trading platforms, such as, IDEX, and in real-time calculate an average live dealer price for a diamond having certain characteristics.

In one example, for a gemstone, e.g., such as a diamond, an average live dealer price may be calculated in real-time. The calculated average live dealer price is the current average wholesale price of a like diamond, i.e., a diamond of the same quality and size (e.g., cut, color, clarity, carat, fluorescence, lab grade). The average live dealer price, allows a customer to be aware, of the current average dealer cost (wholesale cost), as the market changes, of a retailer/dealer's diamonds, thus giving the customer full transparency of what a particular diamond of interest trades for on the wholesale trade platforms in real-time, i.e., that day (the average price the retailer/dealer would pay if the retailer/dealer were to buy the same diamond on one of the wholesale trade platforms).

Using the calculated average live dealer price, the retailer/dealer may set a retail price of, for example, a specific percent above the live dealer price (e.g., 20%), for which the customer may purchase the diamond. In another example, where a customer is looking to sell a diamond to the retailer/dealer, the retailer/dealer 120 may set a buy price, for example, a specific percent below the live dealer price (e.g., 20%), and offer to buy the diamond from the customer for the specific percent below the generated live dealer price. The specific percentage added to or removed from the generated live dealer price may be changeable by, for example, diamond category, quality, carat, market, and/or other characteristic.

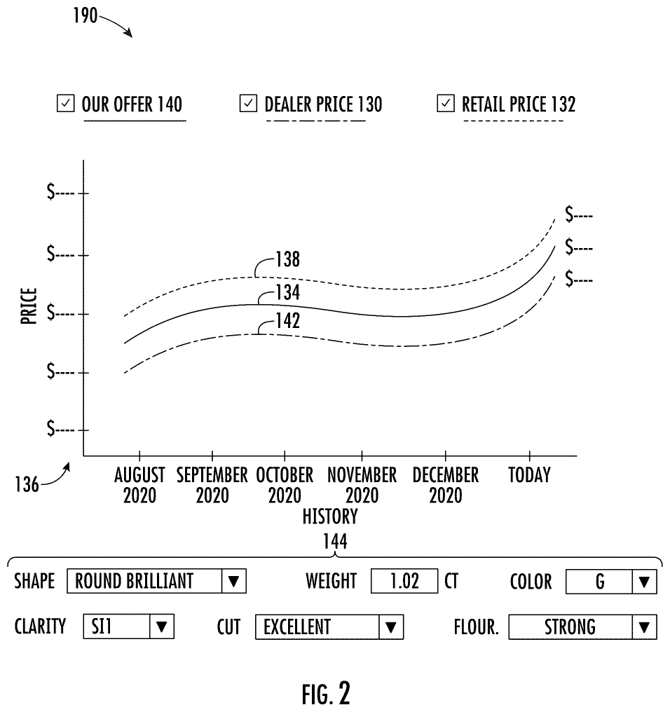

With reference to FIGS. 1-3, in operation, a customer may access a diamond retailer/dealer either at a physical store or electronically online. The customer may identify a diamond of interest from the retailer/dealer's inventory, once the customer has selected a diamond of interest, the retailer/dealer (i.e., user 128) may access gemstone management system 100 via computer 104, and may then select the diamond of interest from its inventory database (e.g., from data store 116). The retailer/dealer may then enter the selected diamond of interest into the live dealer pricing application 110 and enter the diamond's characteristics (e.g., diamond's cut, color, clarity, carat, fluorescence, lab grade, size, and/or other characteristics). The diamond's characteristics may be automatically entered into the live dealer pricing application 110 when selecting the diamond of interest from the retailer/dealer's inventory database, or alternatively the retailer/dealer may manually enter in the diamond's information. The live dealer pricing application 110 of gemstone management system 100, using communications interface 118, may then query the inventory of one or more of data sources 108 via network 106. In one example, live dealer pricing application 110, in real-time, may query the wholesale inventory of, for example, the IDEX, for all available diamonds having the same characteristics as the diamond of interest. The live dealer pricing algorithm 120 of the live dealer pricing application 110 then calculates the average dealer price based on the dealer pricing information for all the retrieved diamonds. Then, live dealer pricing algorithm 120 returns an average live dealer price for the diamond of interest, i.e., average live dealer price 130. In one example, the live dealer pricing application 110 may additionally provide an average price history, showing the average dealer price of such a diamond over a defined period of time, for example the prior 6 months (as shown for example by a curve 134 of a screenshot 180 shown in FIG. 2).

The live dealer pricing application 110, using live dealer pricing algorithm 120, may, based on the calculated average live dealer price 130, automatically calculate a retail price 132. The calculated retail price 132 may be displayed along with the live dealer price 130, for example, on a display of the computer 104 or some other display, for the customer to view. To calculate the retail price 132, the live dealer pricing application 110, via the live dealer pricing algorithm 120, may add a specific percent markup to the calculated average live dealer price 130 and then calculate the retail price 132 by applying the percent markup to the calculated average live dealer price 130. This calculated retail price 132 is the price that the retailer/dealer would sell the diamond to the customer for. In one non-limiting example, the percent markup may be set to 20% above the calculated average live dealer price 130, so in an example where the average live dealer price 130 of the diamond of interest is, for example, $3,975, the retail price 132 would be calculated as $4,770 by the live dealer pricing application 110. In this example, the customer would be able to view both the current calculated average live dealer price 130 of the diamond of interest along with the calculated retail price 132, thereby, providing the customer with a completely transparent experience. This may also be shown as a historical chart, e.g., chart 136, showing the average live dealer price 130 and retail price 132 going back over some period of time (as shown for example by curve 134 and a curve 138, respectively, of screenshot 180 shown in FIG. 2), and may be viewable to the customer in the form of a chart, graph, spreadsheet, or any other suitable form, and may be viewable via a display of computer 104, other display, printout, or other mechanism or form.

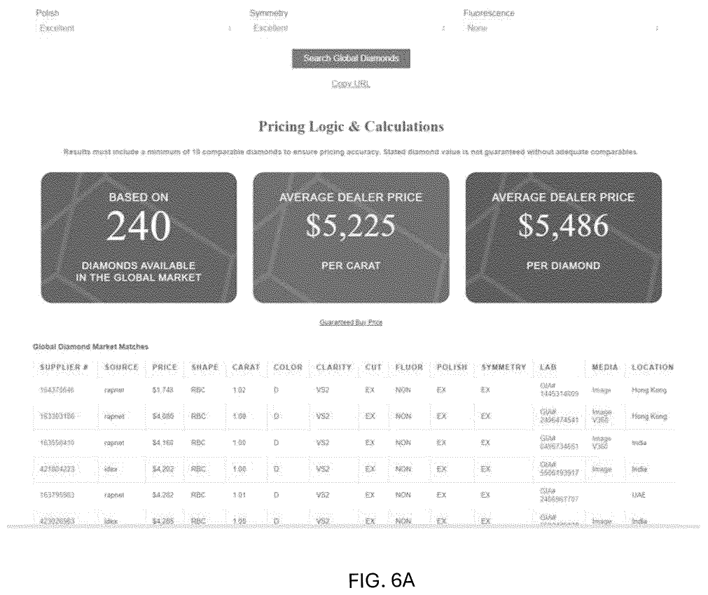

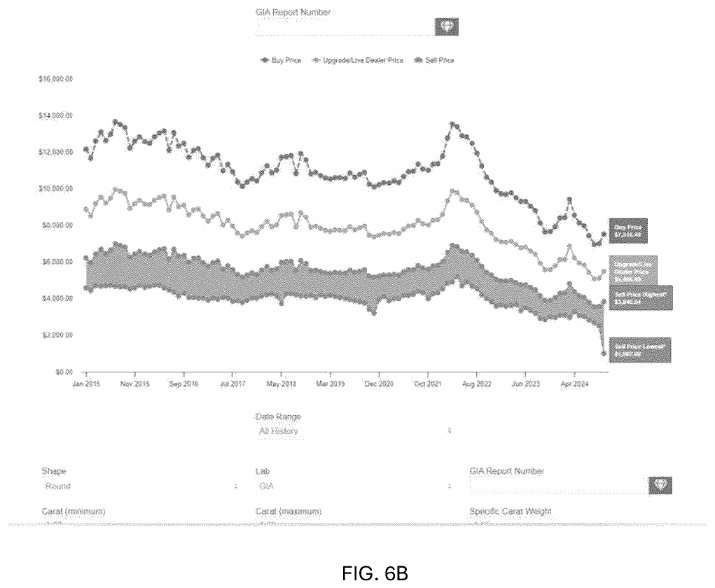

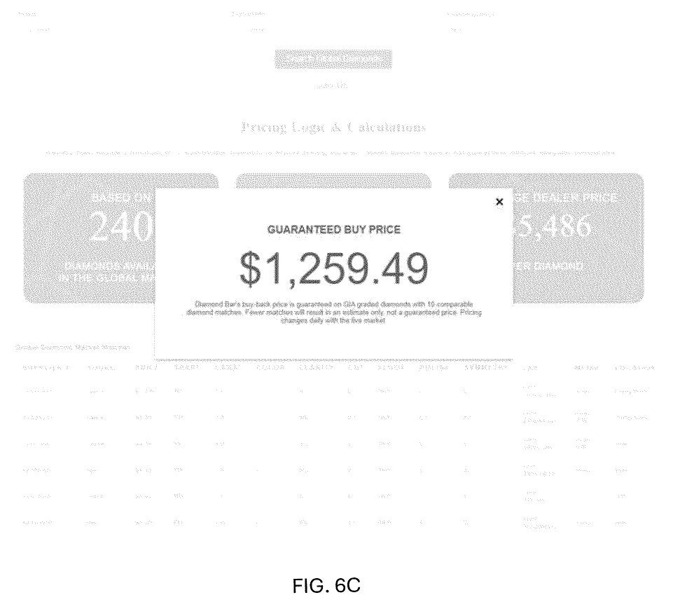

The live dealer pricing application 110 may further automatically calculate a buy price 140 and display it along with the calculated average live dealer price 130. For the buy price 140, the live dealer pricing application 110, via live dealer pricing algorithm 120, may reduce the calculated average live dealer price 130 by a specific percent markdown and automatically calculate the buy price 140. The buy price 140 is the price that the retailer/dealer would buy a diamond from a customer for. In one non-limiting example, the percent markdown may be set to 20% below the calculated average live dealer price 130, so in an example where the average live dealer price 130 of the diamond of interest is, for example, $3,975, the buy price 140 would be calculated as $3,180 by the live dealer pricing application 110. In this example, the customer would be able to view both the calculated current average live dealer price 130 of the diamond along with the calculated buy price 140, thereby, providing the customer with a completely transparent experience. This may also be shown as a historical chart, e.g., chart 136, showing the average live dealer price 130 and buy price 140 going back over some period of time (as shown for example by curve 134 and a curve 142, respectively, of screenshot 180 shown in FIG. 2), and may be viewable to the customer in the form of a chart, graph, spreadsheet, or any other suitable form, and may be viewable via a display of computer 104, other display, printout, or other mechanism or form. With reference to FIGS. 6A-6C, in one example embodiment, live dealer pricing application 110 may further include a guaranteed buy price application. Using the guaranteed buy price application, the retailer/dealer may offer the customer a guaranteed buy price of a particular gemstone. The guaranteed buy price is the price that the retailer/dealer will guarantee the customer that the retailer/dealer would buy back the gemstone for. The guaranteed buy price may be subject to certain requirements before the retailer/dealer will offer the guaranteed buy price. By way of example, the retailer/dealer may require the gemstones be certified/graded by certain gemstone grading/certifying entities, such as, but not limited to the Gemological Institute of America (GIA), and may also require that a certain minimum number of comparable gemstone matches be found (e.g., 10). In such an embodiment, a customer may access a customer facing portion of the retailer/dealer's live dealer pricing application 110 (either online or onsite), and enter certain information for the customer's gemstone (e.g., attributes and/or certification number). Once entered, the live dealer pricing application 110 may calculate the average live dealer price 130 and/or the retail price 132, and display either or both, and may also display historical pricing charts of the same. The number of comparable gemstones the average live dealer price 130 and/or the retail price 132 were calculated off of may also be displayed. Provided the customer's gemstone meets the certain requirements, the customer may select to receive a guaranteed buy price for the gemstone. Upon selecting to receive a guaranteed buy price, the guaranteed buy price application generates the guaranteed buy price, and displays it to the customer. Note, the subject gemstone may be one the customer already owns or one the customer is interested in buying, and wants to know what the retailer/dealer would buy it back for should the customer wish to sell it back or trade it in.

In one example, the customer would be able to view the calculated current average live dealer price 130 of the diamond along with the calculated retail price 132 and the calculated buy price 140. In this example, the customer knows what the current average dealer price 130 is, the retail purchase price 132, as well as the price the retailer/dealer would by the diamond back for, the buy price 140, thereby, the percent markup for retail purchase and percent markdown for buy back is completely transparent to the customer. This may also be shown as a historical chart, e.g., chart 136, showing the average live dealer price 130, retail price 132, buy price 140 going back over some period of time (as shown for example by curves 134, 138, and 142, respectively, of screenshot 180 shown in FIG. 2), and may be viewable to the customer in the form of a chart, graph, spreadsheet, or any other suitable form, and may be viewable via a display of computer 104, other display, printout, or other mechanism or form.

In one example, gemstone management system 100, may further display the diamond (or gemstone) information 144 of the selected diamond (or gemstone) of interest, for example, but not limited to, the diamond's/gemstone's cut, color, clarity, carat, fluorescence, lab grade, size, photograph and/or other information along with the average live dealer price 130, retail price 132, and/or buy price 140, and/or historical chart/graph. In one example, diamond or gemstone information 144 may reside at data sources 108, which may be accessible via network 106 using, for example, live dealer pricing application 110. An example of diamond/gemstone information 144 is shown in screenshot 190 of FIG. 2.

Additionally, diamond/gemstone information for a particular diamond/gemstone may be provided in the form of a diamond and gemstone grading report. Generally, grading reports are meant to provide clarity about the specifications of diamonds and gemstones. A grading report can help explain the quality factors like color, clarity, cut and carat weight. Diamond and gemstone grading reports are provided by laboratories within the jewelry industry. Examples of organizations that offer diamond and gemstone grading reports or certificates may include, but are not limited to, the Gem Certification & Assurance Lab (GCAL), the Gemological Institute of America (GIA), the Gemological Science International (GSI), EGL USA, and the International Gemological Institute (IGI).

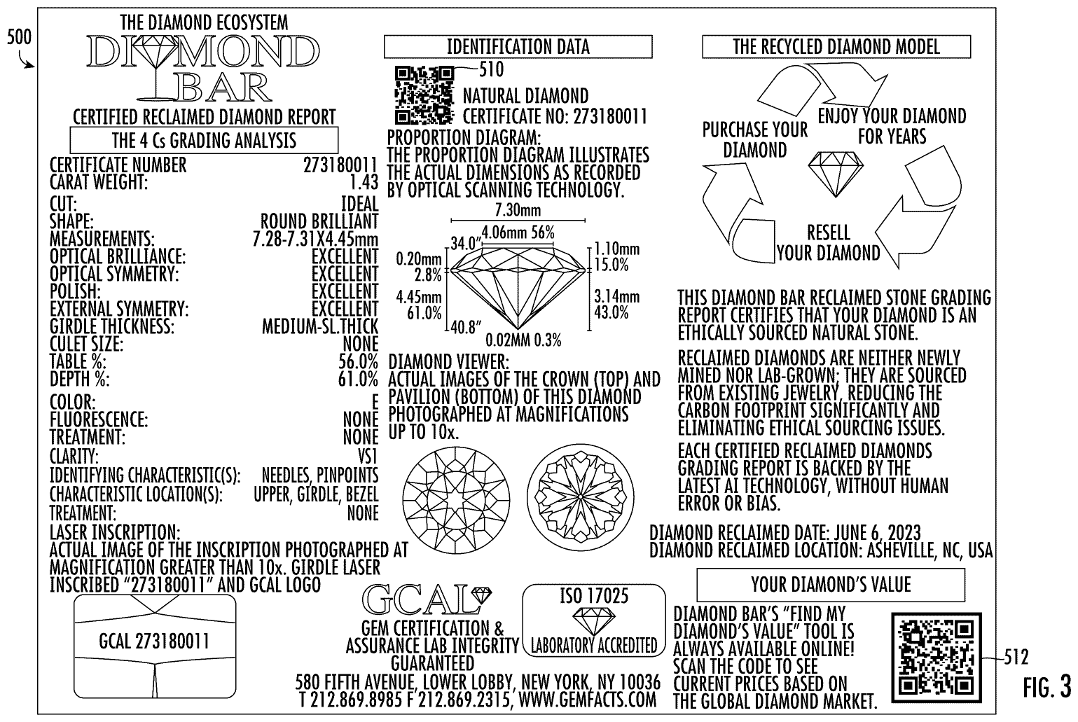

By way of example, FIG. 3 shows a screenshot of an example of a diamond/gemstone grading report 500, in accordance with an embodiment of the invention. In this example, diamond/gemstone grading report 500 may indicate one or more weblinks to other information about the diamond (or gemstone). Diamond/gemstone grading report 500 may be in a digital/electronic and/or physical (e.g., printed) format.

In one example, diamond/gemstone grading report 500 may include a pricing weblink, such as QR code or barcode 512. Pricing QR code or barcode 512 may be scanned and used to automatically direct a user 128 or customer 129 to pricing or value information that is available online. The online pricing or value information may be current information that is assessable in real time. In another example, diamond/gemstone grading report 500 may also include a certificate QR code or barcode 510. Certificate QR code or barcode 510 may be scanned and used to automatically direct a user 128 or customer 129 to the diamond/gemstone certificate information that is available online. Pricing QR code or barcode 512 and/or certificate QR code or barcode 510 may be any type of machine readable media.

In particular, the presence of a pricing QR code or barcode (e.g., pricing QR code or barcode 512) on the grading report (e.g., diamond/gemstone grading report 500) provides transparency that allows customers 129 to understand exactly what they are paying, what their diamond/gemstone is worth, and what they potentially would get should they decide to sell their diamond/gemstone (or trade it in) back to the retailer/dealer. This builds a tremendous amount of trust and customer loyalty because the customer 129 has all the information and does not have to worry if they are getting a fair deal or not, i.e., not being charged 100%+ markups or taking significant losses on their diamonds/gemstone when selling back to a jeweler or pawn broker. Every time customers 129 buy or sell a diamond/gemstone they know the current real time wholesale (dealer price) and the exact markup or markdown that will be applied.

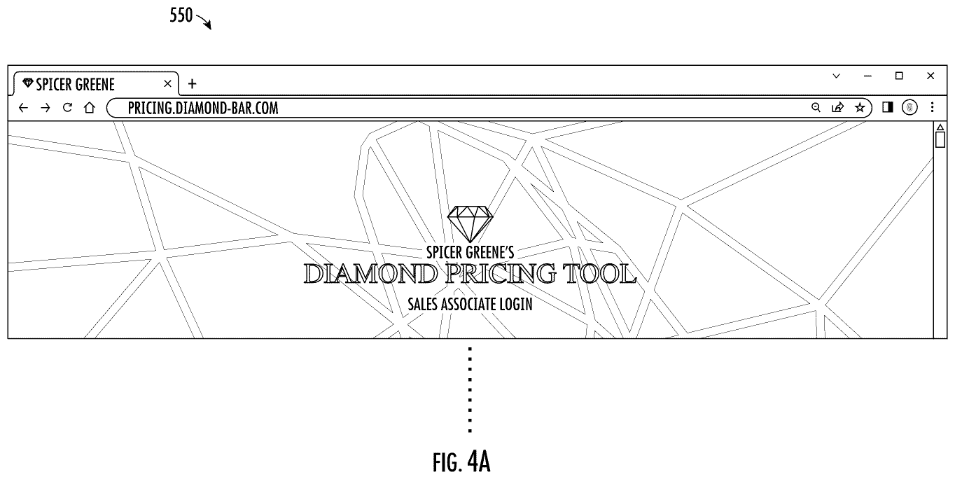

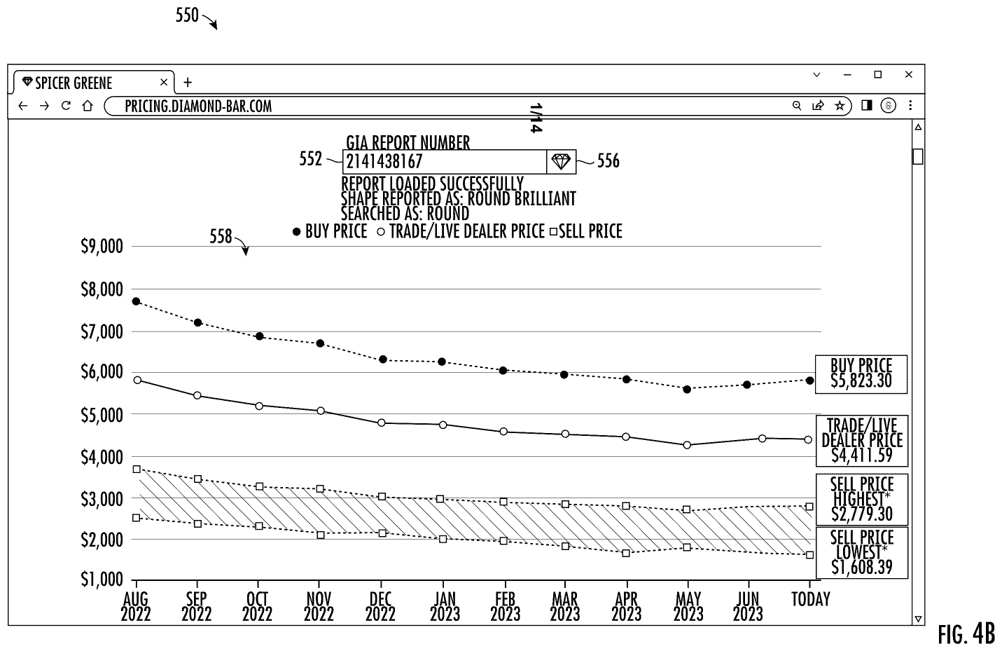

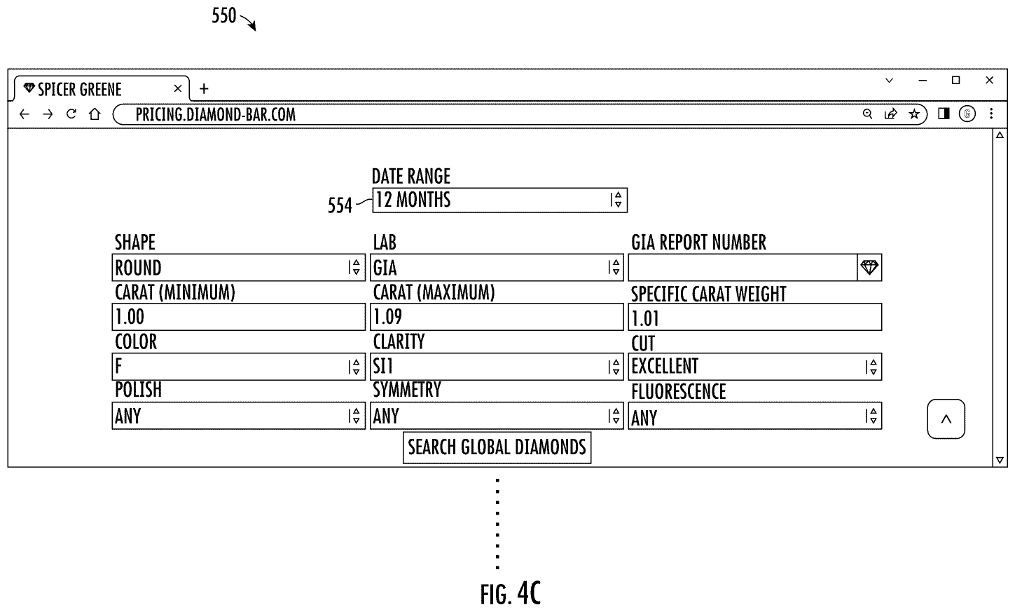

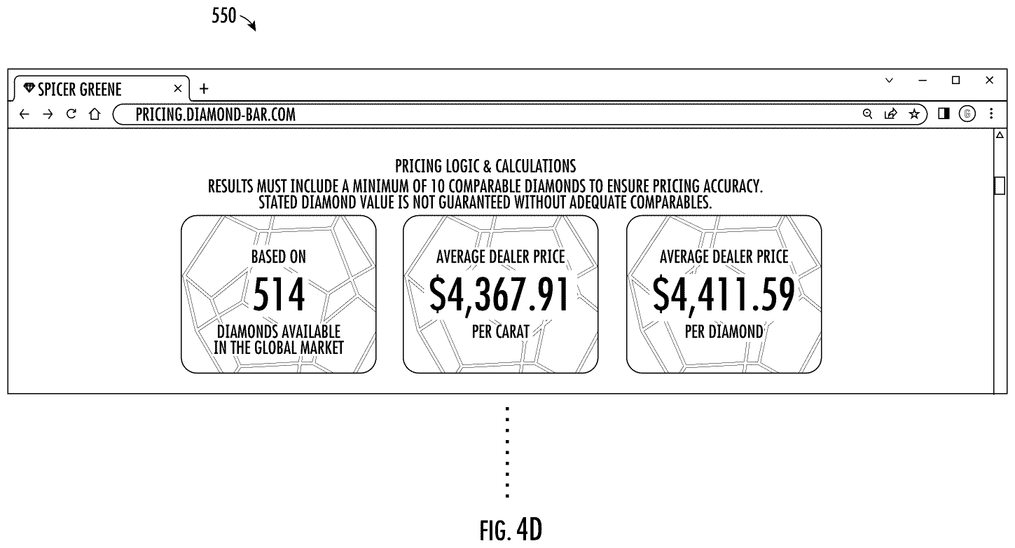

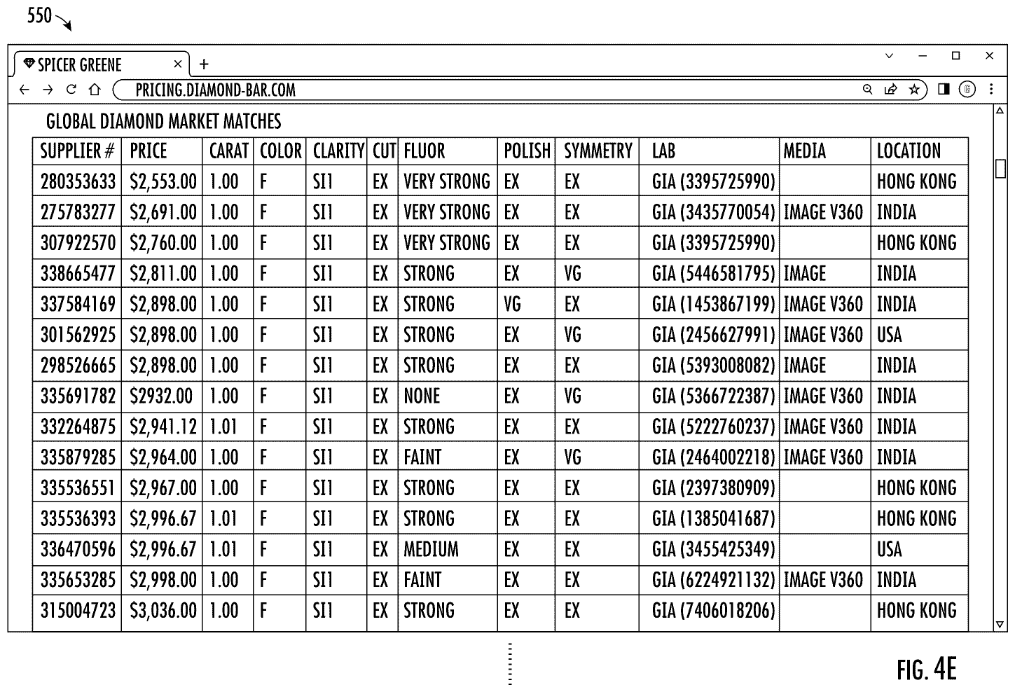

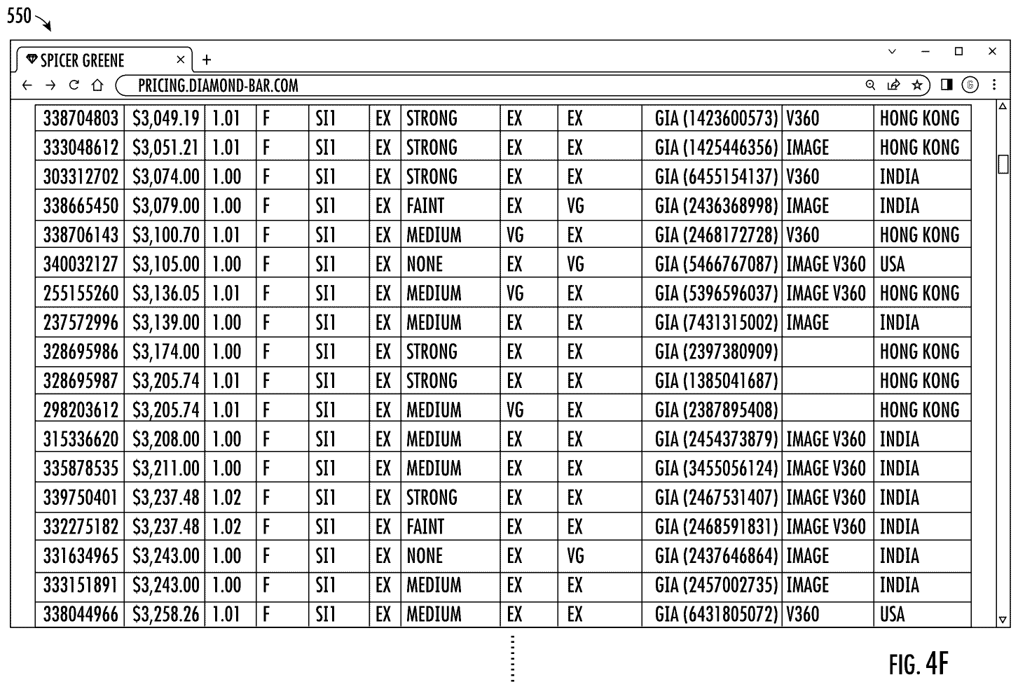

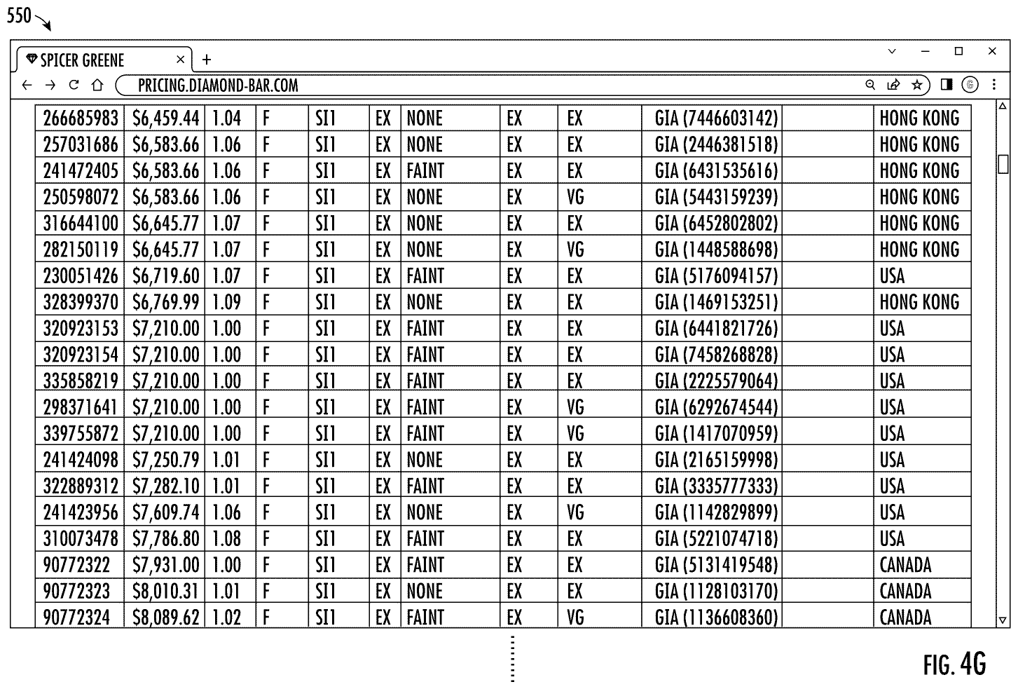

FIG. 3 shows a screenshot of an example of a diamond/gemstone grading report 500. Further to the example, FIG. 4A through FIG. 4G are example screenshots of an example of an online diamond/gemstone pricing tool 550 that may be accessed using the weblink (e.g., pricing QR code or barcode 512) on the diamond/gemstone grading report 500. Online diamond/gemstone pricing tool 550 may be, for example, a diamond/gemstone pricing or value website for use by users 128 and/or customers 129. For example, a customer 129 may scan pricing QR code or barcode 512 of diamond/gemstone grading report 500 using his/her smartphone or smart device and be automatically directed to online diamond/gemstone pricing tool 550.

FIG. 4B shows a Report Number field 552 for entering a report number (e.g., GIA 2141438167), which may be entered manually or automatically upon scanning pricing QR code or barcode 512. FIG. 4C shows a Date Range field 554 for entering a date range (e.g., All History, 12 Months). In one example, after filling in the Report Number field 552 (either manually or automatically) and optionally the Date Range field 554, the customer 129 may hit the Submit button 556 shown on FIG. 4B, which prompts the retrieval of real time pricing information about the diamond/gemstone of interest. In another example, upon scanning the pricing QR code or barcode 512 the real time pricing information about the diamond/gemstone of interest is automatically retrieved.

The retrieved information about the diamond/gemstone of interest, may include, for example, a plot 558, as shown for example on FIG. 4B, and may further include one or more of the information fields shown in FIG. 4C, which may be automatically populated. Further, retrieved information about the diamond/gemstone of interest, may include, for example, as shown in FIG. 4D, the number of diamonds/gemstones that may be comparable to the diamond/gemstone of interest, an average dealer price per carat, an average dealer price per diamond/gemstone, and/or other pricing information. Further, as shown in FIG. 4E, FIG. 4F, and FIG. 4G, the retrieved information about the diamond/gemstone of interest, may include, for example, a sampling of the global diamond/gemstone market matches. Accordingly, online diamond/gemstone pricing tool 550 allows users 128 and/or customers 129 to understand exactly what they are paying, what their diamond/gemstone is worth, and what they potentially would get should they decide to sell their diamond/gemstone (or trade it in) back to the retailer/dealer, and all in real time.

In gemstone management system 100, when scanned, pricing QR code or barcode 512 on diamond/gemstone grading report 500 may be used to access real time pricing data along with other information in the linked webpage of online diamond/gemstone pricing tool 550. This may provide an added advantage of the pricing data always being current, which is particularly useful because the diamond/gemstone market fluctuates.

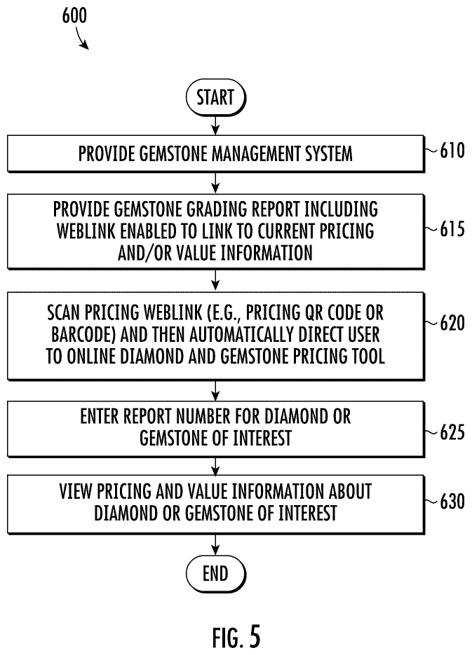

Referring now to FIG. 5 is a flow diagram of an example of a method 600 of using the gemstone management system 100 including diamond/gemstone grading report 500, in accordance with an embodiment of the invention. Method 600 may include one or more of, but is not limited to, the following steps and in any order.

At a step 610, a gemstone management system including diamond/gemstone grading report 500 is provided. For example, gemstone management system 100 described above in FIG. 1 through FIG. 4G may be provided.

At a step 615, a gemstone grading report including a weblink to current pricing and/or value information is provided. For example, diamond/gemstone grading report 500 as shown in FIG. 3 may be provided. Diamond/gemstone grading report 500 may include a weblink, such as pricing QR code or barcode 512, to current pricing and/or value information. Diamond/gemstone grading report 500 may also include a weblink, such as certificate QR code or barcode 510, to current diamond/gemstone certificate information.

At a step 620, the pricing weblink (e.g., pricing QR code or barcode) may be scanned and then the user may be automatically directed to the online diamond/gemstone pricing tool. For example, a customer 129 may scan pricing QR code or barcode 512 of diamond/gemstone grading report 500 using his/her smartphone or smart device and then be automatically directed to online diamond/gemstone pricing tool 550 shown, for example, in FIG. 4A through FIG. 4G.

At a step 625, the report number for the diamond/gemstone of interest may be entered, either manually or automatically. For example, the report number for the diamond/gemstone of interest may be entered, either manually or automatically, into Report Number field 552 of online diamond pricing tool 550, as shown, for example, in FIG. 4B. Additionally, a date range of information may be entered into Date Range field 554, as shown, for example, in FIG. 4C.

At a step 630, the pricing and value information about the diamond/gemstone of interest may be displayed for viewing. For example, after the Report Number field 552 is filled in and if needed the Date Range field 554 is filled in, the customer 129 may hit the Submit button 556, as shown for example on FIG. 4B, which prompts the retrieval of information about the diamond/gemstone of interest. For example, plot 558, shown on FIG. 4B, and/or one or more of the information fields shown in FIG. 4C may be automatically populated. Further, as shown for example in FIG. 4D, the number of diamonds that may be comparable to the diamond/gemstone of interest, an average dealer price per carat, an average dealer price per diamond/gemstone, and/or other pricing/value information may be shown. Further, as shown for example in FIG. 4E, FIG. 4F, and FIG. 4G a sampling of the global diamond/gemstone market matches may be shown.

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

The terms “comprise,” “comprises,” “comprising,” “include,” “includes,” and “including,” are intended to be non-limiting, such that recitation of items in a list is not to the exclusion of other like items that may be substituted or added to the listed items.

Terms like “preferably,” “commonly,” and “typically” are not utilized herein to limit the scope of the claimed embodiments or to imply that certain features are critical or essential to the structure or function of the claimed embodiments. These terms are intended to highlight alternative or additional features that may or may not be utilized in a particular embodiment of the present invention.

The term “substantially” is utilized herein to represent the inherent degree of uncertainty that may be attributed to any quantitative comparison, value, measurement, or other representation and to represent the degree by which a quantitative representation may vary from a stated reference without resulting in a change in the basic function of the subject matter at issue.

Various modifications and variations of the disclosed methods, compositions and uses of the invention will be apparent to the skilled person without departing from the scope and spirit of the invention. Although the subject matter has been disclosed in connection with specific preferred aspects or embodiments, it should be understood that the subject matter as claimed should not be unduly limited to such specific aspects or embodiments.

The subject matter may be implemented using hardware, software, or a combination thereof and may be implemented in one or more computer systems or other processing systems. In one aspect, the subject matter is directed toward one or more computer systems capable of carrying out the functionality described herein.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the presently disclosed subject matter. For example, the term “about,” when referring to a value can be meant to encompass variations of, in some embodiments ±100%, in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

Although the foregoing subject matter has been described in some detail by way of illustration and example for purposes of clarity of understanding, it will be understood by those skilled in the art that certain changes and modifications can be practiced within the scope of the appended claims.

That which is claimed:

1. A gemstone grading report system, comprising:
a. a gemstone grading report associated with a gemstone;
b. gemstone data of the gemstone displayed or printed on the gemstone grading report; and
c. one or more weblinks comprising machine readable media displayed or printed on the gemstone grading report, wherein at least one of the one or more weblinks is configured to, upon reading the machine readable media by a computing device, link the computing device to real-time pricing information of the gemstone.

2. The system of claim 1, wherein the gemstone data comprises characteristics of the gemstone, the characteristics comprising one or more of gemstone type, cut, color, clarity, carat, size, fluorescence, lab grade, dimensions, diagrams, certificate number, images, grading lab, source, and/or source history of gemstone.

3. The system of claim 1, wherein the one or more weblinks comprises at least two weblinks, and wherein one of the at least two weblinks is configured to link the computing device to certificate information of the gemstone.

4. The system of claim 1, wherein the gemstone grading report comprises one of a digital/electronic format and/or a physical format.

5. The system of claim 1, wherein the machine readable media of the one or more weblinks comprises any of a QR code or a bar code.

6. The system of claim 1, wherein the pricing information of the gemstone comprises current pricing and/or value information that is assessable in real time.

7. The system of claim 1, further comprising a live pricing application, wherein the computing device automatically accesses the live pricing application upon reading the machine readable media, and wherein the live pricing application comprises a live pricing algorithm and a live pricing tool graphical user interface.

8. The system of claim 7, wherein the live pricing application is further configured to automatically query one or more online gemstone trading platforms for pricing information of gemstones comparable to the gemstone of the gemstone grading report.

9. The system of claim 8, wherein the live pricing application is further configured to automatically analyze the queried pricing information, and using the live pricing algorithm calculate in real-time the real-time pricing information for the gemstone of the gemstone grading report.

10. The system of claim 9, wherein the real-time pricing information comprises an average dealer price for the gemstone of the gemstone grading report.

11. The system of claim 10, wherein the real-time pricing information further comprises either or both of a calculated retail price and/or a calculated buy price for the gemstone of the gemstone grading report.

12. The system of claim 10, wherein calculating the average dealer price comprises averaging the real-time pricing information for all gemstones retrieved from the query of the one or more online gemstone trading platforms.

13. The system of claim 10, wherein calculating the average dealer price further comprises averaging the real-time pricing information for all gemstones retrieved from the query of the one or more online gemstone trading platforms going back a defined period of time and generating historical average dealer prices spanning over the defined period of time.

14. The system of claim 10, wherein the calculated real-time pricing information is viewable via the live pricing tool graphical user interface.

15. A method of using a gemstone grading report system, comprising:
a. providing a gemstone grading report of a gemstone, comprising:
i. gemstone data of the gemstone displayed or printed on the gemstone grading report; and
ii. one or more weblinks comprising machine readable media displayed or printed on the gemstone grading report, wherein at least one of the one or more weblinks is configured to, upon reading the machine readable media by a computing device, link the computing device to real-time pricing information of the gemstone;
b. activating the at least one of the one or more weblinks, wherein activating the at least one of the one or more weblinks comprises reading the machine readable media by the computing device;
c. accessing a live pricing application of a gemstone pricing tool via the activated one of the one or more weblinks; and
d. viewing the real-time pricing information of the gemstone.

16. The method of claim 15, further comprising after accessing the live pricing application, entering any additional required information of the gemstone into the live pricing application not automatically entered therein.

17. The method of claim 15, wherein the gemstone data comprises characteristics of the gemstone, the characteristics comprising one or more of gemstone type, cut, color, clarity, carat, size, fluorescence, lab grade, dimensions, diagrams, certificate number, images, grading lab, source, and/or source history of gemstone.

18. The method of claim 15, wherein the one or more weblinks comprises at least two weblinks, and wherein one of the at least two weblinks is configured to link the computing device to certificate information of the gemstone.

19. The method of claim 15, wherein the gemstone grading report comprises one of a digital/electronic format and/or a physical format.

20. The method of claim 15, wherein the machine readable media of the one or more weblinks comprises any of a QR code or a bar code.

21. The method of claim 15, wherein the pricing information of the gemstone comprises current pricing and/or value information that is assessable in real time.

22. The method of claim 15, further comprising a live pricing application, wherein the computing device accesses the live pricing application upon reading the machine readable media, and wherein the live pricing application comprises a live pricing algorithm and a live pricing tool graphical user interface.

23. The method of claim 22, wherein the live pricing application is further configured to query one or more gemstone trading platforms for pricing information of gemstones having substantially similar characteristics as that of the gemstone of the gemstone grading report.

24. The method of claim 23, wherein the live pricing application is further configured to analyze the queried pricing information and using the live pricing algorithm calculate the real-time pricing information for the gemstone of the gemstone grading report.

25. The method of claim 24, wherein the real-time pricing information comprises an average dealer price along with either or both of a calculated retail price and/or a calculated buy price for the gemstone of the gemstone grading report.

26. The method of claim 25, wherein calculating the average dealer price comprises averaging the real-time pricing information for all gemstones retrieved from the query of the one or more gemstone trading platforms.

27. The method of claim 15, wherein the real-time pricing information is viewable via the live pricing tool graphical user interface.
